(19) United States
(12) Patent Application Publication
(10) Pub. No.: US 2011/0253853 A1
(43) Pub. Date: Oct. 20, 2011

(54) HINGE REINFORCEMENT FOR A MOTOR VEHICLE DOOR HINGE

(75) Inventor: Michael HORNECK, Ruesselsheim (DE)

(73) Assignee: GM GLOBAL TECHNOLOGY OPERATIONS LLC, Detroit, MI (US)

(21) Appl. No.: 13/086,055

(22) Filed: Apr. 13, 2011

(30) Foreign Application Priority Data
Apr. 17, 2010 (DE) 102010015290.0

(51) Int. Cl. F16M 13/02; B23P 11/00; F16B 47/00

(52) U.S. Cl. 248/205.4; 248/220.21; 248/224.8; 29/428

(57) ABSTRACT

A hinge reinforcement for a motor vehicle door hinge for securing a hinge joint to the bearing structure of a motor vehicle body, with a base plate that can be slidably attached to a side of the bearing structure facing away from the hinge joint in a pre-assembly position by means of a bracket. The base plate is designed to accommodate a thermally activatable fixing means, with which the base plate can be fixed to the bearing structure in a final assembly position.

### CROSS-REFERENCE TO RELATED APPLICATION

This application claims priority to German Patent Application No. 102010015290.0, filed Apr. 17, 2010, which is incorporated herein by reference in its entirety.

### TECHNICAL FIELD

The technical field relates to a hinge reinforcement for a motor vehicle door hinge, which preferably can be arranged on a side of the vehicle bearing structure facing away from the door hinge, for example a vehicle body component or a vehicle door, and interacts directly with the door hinge for securing the latter.

### BACKGROUND

Hinge reinforcements are preferably used to pivot motor vehicle doors to a motor vehicle body. For example, conventional hinge reinforcements are welded to the doorframe, and to this extent provide a structure-reinforcing attachment point for a door hinge. In particular the precision adjustment and requirement to again remove a vehicle door from the car body shell after the latter has been completed have at times proven to be rather expensive and complicated in prior art.

Known for example from DE 43 35 163 A1 is a hinge connection system, wherein a door can be adjusted by means of a special profile in the X-Y-Z plane. The outer shell of the door here exhibits an extruded profile with a C-groove running in the traveling direction, into which an anchoring section can be adjustably inserted as a sliding block in the longitudinal direction of the vehicle, or shifted herein.

Also known in prior art are embodiments of hinge reinforcements in which the hinge reinforcement is secured on a side of a doorframe facing away from the actual hinge, or on a corresponding door bearing structure, wherein final assembly of the reinforcement only takes place as the door hinge is bolted with the opposing hinge reinforcement through the bearing structure.

In order to ensure a precisely fitting assembly that minimizes component tolerances, it can here be provided that both the hinge reinforcement and the door hinge be secured to the bearing structure so that they can slide within certain tolerances. However, if the door that has already been mounted in one stage of bodywork is to be temporarily dismantled again in the course of manufacturing the motor vehicle, the ensuing final assembly of the vehicle door requires a comparably complicated adjustment.

Therefore, at least one object is to provide a hinge reinforcement that enables a simple and less time-intensive, and yet precise and permanent, assembly of a vehicle door on the vehicle body. In addition, at least another object is to provide a correspondingly simplified assembly method, as well as to reduce the manufacturing and assembly costs.

### SUMMARY

The hinge reinforcement according to an embodiment is designed for a motor vehicle door hinge. The hinge reinforcement has at least one base plate, which is preferably provided or already provided with an attachment means for the hinge joint, or which already exhibits a corresponding attachment means. The base plate can be movably secured to a bearing structure of the vehicle body or vehicle door in a pre-assembly position by means of a bracket.

In this case, the base plate must be arranged on the side of the bearing structure facing away from the hinge joint. In order to attach the hinge joint and vehicle door preferably joined with the hinge joint, it is provided in particular that the hinge joint be joined with the hinge reinforcement in such a way as to clamp the bearing structure between the hinge reinforcement and hinge joint, preferably between the base plate of the hinge reinforcement and the hinge joint. However, in the pre-assembly position, the base plate is slidably secured to the bearing structure by means of a bracket furnished separately for this purpose. This ability to slide enables a tolerance-compensating and precisely fitting assembly of the hinge joint or vehicle door to the vehicle body.

The base plate is further designed to accommodate a thermally activatable fixing means, with which the base plate can be fixed on the bearing structure in a final assembly position, for example one envisaged by a door assembly process. For example, the thermally activatable fixing means can be used to keep the base plate fixed on the bearing structure unchanged, even after a door attachment means has been temporarily detached.

The adjustment of the door relative to the motor vehicle body introduced in the course of assembly work on the door can be retained by activating the fixing means in a subsequent additional motor vehicle assembly process. As a consequence, readjustment is no longer required when again assembling the motor vehicle door.

In a first embodiment, the fixing means exhibits a thermally activatable adhesive. The fixing means can also be directly designed as a thermally activatable adhesive. For example, the adhesive suitable for bonding the base plate and bearing structure can initially be provided with a protective sheath, which only melts and releases the adhesive after a predetermined temperature has been reached. In this respect, such a protective layer prevents the adhesive from having its adhesive effect in the pre-assembly position. As a result, there is little or no impediment to adjusting the hinge arrangement, which is accompanied by a shifting of the base plate relative to the bearing structure.

In another embodiment, the base plate exhibits the fixing means or is equipped with the latter. For example, the fixing means can be arranged on the base plate, as well as secured thereto. The fixing means can also be arranged in a receptacle or depression in the base plate provided for this purpose.

Another embodiment provides that the base plate exhibit a receptacle for the fixing means on its side facing the bearing structure. It is advantageous to insert the adhesive into this receptacle before the base plate is secured to the bearing structure in the pre-assembly position. The receptacle provided for the fixing means is here open toward the base plate, so that as the adhesive is softened or activated, it can bring about an adhesive bond between the base plate and bearing structure in the area of the base plate receptacle.

A preferred embodiment further provides that the base plate with two or more parts, and exhibit at least an upper plate and a lower plate. The upper and lower plate here essentially overlap each other and are aligned parallel to each other, so that the upper and lower plate lie on top of each other with their essentially flat surfaces in the pre-assembly position already. The lower plate preferably comes to abut the bearing structure with its bottom side.

The upper and lower plate also each have at least one through opening for an attachment bolt that penetrates through the bearing structure or some similar attachment means. At least two such through openings are preferably provided in the area of the plate end sections. Through openings in the lower and upper plate come to rest against each other in essentially a flush manner, so that the attachment bolt provided for attaching the hinge joint can pass through both the bearing structure and the two plates, and form an active connection with a suitable counter-attachment means, preferably on the top side of the upper plate, so as to exert a clamping force on the bearing structure component.

Attachment nuts corresponding in design with the attachment bolt are preferably furnished in the upper plate or top side of the upper plate. For example, these can be joined as a single piece with the upper plate, designed as welding nuts, or fixedly connected with the upper plate via comparable attachment means.

During the course of pre-assembly, for example, the base plate slidably held against the bearing structure via the bracket can be shifted in such a way that a vehicle door can be mounted in a precisely fitting manner in a door opening in the body. By securely tightening one or more attachment or screw bolts passing through the base plate and bearing structure, the hinge reinforcement along with the opposing hinge joint located on the other side of the bearing structure can be fixed precisely in terms of fit and position.

As soon as the body shell configured in this way is exposed to thermal treatment during a painting process, the fixing means provided in the base plate is activated, ensuring that the base plate is additionally fixed to the bearing structure. If the vehicle door is again unbolted after the thermal treatment, for example after the vehicle body has been painted, the fixing means keeps the base plate in the same location on the bearing structure. As a result, the door hinge and/or hinge reinforcement no longer need to be readjusted when again attaching the vehicle door. The fixing means preferably composed of an adhesive keeps the nuts or comparable attachment means located on the base plate in their precise, final assembled position during the entire remaining assembly process.

In another embodiment, the lower plate comes to abut the bearing structure directly in its assembly position. The upper plate further rests against the lower plate, and has at least one extension, which projects over the side edge of the lower plate. This projecting extension or cam can be used to join the upper plate flush with the bracket. The positive connection here provides that the upper plate, and hence even the lower plate, can be fixed to the bearing structure so that it can shift relative to the bracket or relative to the bearing structure within predefined tolerances.

In another embodiment, the bracket is designed as a strap that at least regionally overlaps the base plate. The bracket itself is here preferably permanently secured to the bearing structure, for example bonded firmly by means of a welded joint or adhesive process.

In another preferred embodiment of the invention, the bracket advantageously has at least one through opening for accommodating the at least one extension of the base plate, preferably the upper plate of the base plate.

In comparison to the geometry of the extensions, the through opening or plurality of through openings exhibit a somewhat greater expansion along the plate plane, so that the base plate can be shifted or finely adjusted relative to the bracket and/or bearing structure while being moved in the pre-assembly position on the base plate.

In another preferred embodiment, the bracket exhibits attachment extensions resembling loops, which in the assembly position extend essentially parallel to the plane of the bearing structure. These attachment extensions can further resemble flanges, for example to weld the bracket fixedly to the bearing structure. The through openings of the bracket provided for the projections of the upper plate preferably adjoin these attachment extensions directly.

It is further preferable for the bracket to overlap the base plate transversely relative to its longitudinal direction, and for the base plate to exhibit the kind of curved progression viewed in the longitudinal direction in which the longitudinal ends of the base plate come to align roughly flush with the outlying edge of at least one attachment extension of the bracket. This makes it possible to provide a hinge reinforcement with a compact overall design.

In addition, having a base plate curved like a banana and/or tapered somewhat in the middle makes it possible to shift the base plate within prescribed limits viewed in the longitudinal direction. For example, the bracket can exhibit in particular an opening cross section for accommodating the base plate that is smaller than the cross section of the longitudinal ends of the base plate. This makes it possible to prevent the base plate from being pulled out or dropping out of the bracket in the longitudinal direction of the base plate.

In addition, an embodiment can provide that the bracket exhibit a clamping means that acts as a pressure pad facing the base plate. It is here provided in particular that the area of the bracket spanning the upper plate of the base plate exhibits a spring or clamping element directed toward the upper plate, for example which can be designed like a loop curved toward the base plate.

The bracket, clamping means and thickness of the upper and lower plate are here tailored to each other in such a way that securing the bracket to the bearing structure generates a clamping force acting on the base plate in the direction of the normal to the surface, thereby allowing the base plate to shift in the base plate plane, but largely preventing any spontaneous slippage by the base plate relative to the bracket and/or relative to the bearing structure. It is also preferable for the lower plate to have a recess to form the receptacle for the adhesive.

Another embodiment can provide in particular that the upper and lower plate are designed as stampings, so that a receptacle open only toward the bearing structure can be created for the adhesive or fixing means by stacking the upper and lower plate one on top of the other. In this way, a receptacle for the fixing means can be prepared in the base plate without any machining, drilling or sawing operations.

In addition, the bearing structure provided for securing the hinge joint and hinge reinforcement is designed as part of a vehicle door and/or as part of a vehicle body. Depending on the envisaged installation situation, the hinge reinforcement can be pre-assembled on the door wing or doorframe.

In another embodiment, a vehicle door is provided with a hinge reinforcement according to the invention and pre-configured accordingly. In addition, a motor vehicle is provided with such a vehicle door or a hinge reinforcement. Yet another embodiment further relates to a method for assembling a vehicle door on the body of a motor vehicle using the hinge reinforcement described above. In this case, the base plate of the hinge reinforcement is slidably secured by a bracket to a bearing structure of the vehicle door and/or the vehicle body in a pre-assembly position.

This is preferably accomplished by welding the bracket provided for the slidable attachment of the base plate to the bearing structure. In an assembly process, a door hinge is then engaged with the base plate by means of at least one attachment means that penetrates through the base plate and bearing structure, preferably with a bolt, in such a way as to clamp the bearing structure between the door hinge and base plate. Weld nuts and/or clinch nuts are preferably arranged on the side of the base plate facing away from the bearing structure for this purpose, into which bolts insertable from the door hinge can be screwed. It is further conceivable to equip the base plate itself with a through opening provided with a female thread.

While reciprocally clamping the base plate, bearing structure and door hinge together, the door hinge is aligned together with the base plate on the bearing structure in such a way that the vehicle door assumes its final assembly position. At least the base plate exhibiting a thermal fixing means is subsequently subjected to thermal treatment, during which the fixing means arranged inside the base plate and directly abutting the bearing structure is thermally activated. This type of thermal activation is provided in particular in the course of a painting or drying process, for example during cataphoric dip coating (CDC), when the body shell goes through a thermal treatment step anyway.

The hinge reinforcement is then precisely positioned on the bearing structure of the door and attached thereto, so that the door can be easily unbolted from the body again, and reattached to the body in an especially simple manner in an ensuing final assembly process, without any further adjustments.

### BRIEF DESCRIPTION OF THE DRAWINGS

The present invention will hereinafter be described in conjunction with the following drawing figures, wherein like numerals denote like elements, and:

FIG. 1 is a perspective view of a hinge reinforcement according to an embodiment in the assembly position;

FIG. 2 is an exploded view of the hinge reinforcement, showing its individual parts; and

FIG. 3 is a perspective and partially cut view of a vehicle door.

### DETAILED DESCRIPTION

The following detailed description is merely exemplary in nature and is not intended to limit application and uses. Furthermore, there is no intention to be bound by any theory presented in the preceding background or summary or the following detailed description.

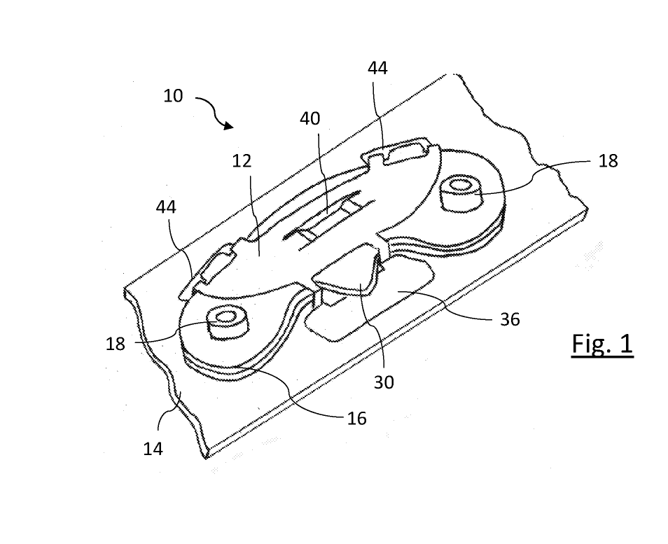

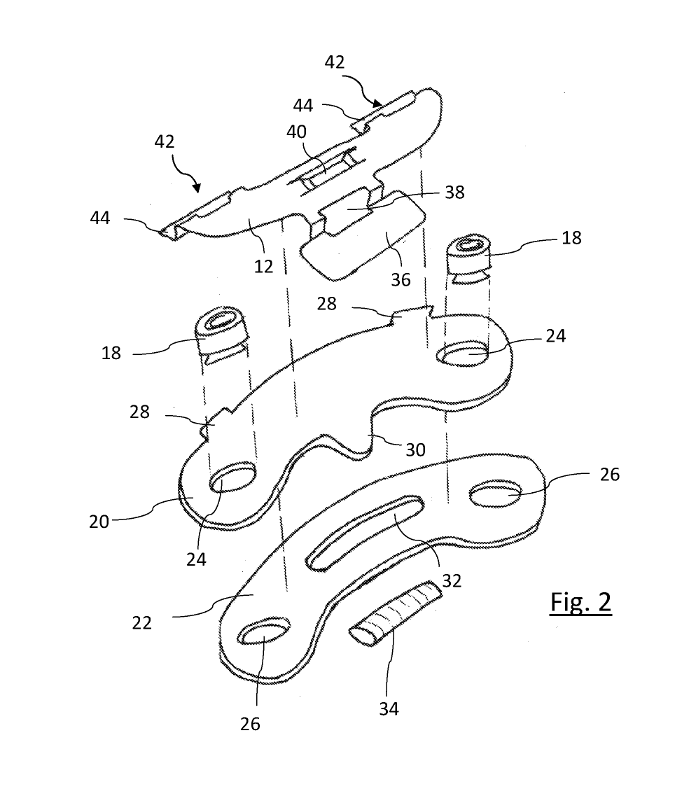

FIG. 1 and FIG. 2 provide an isolated view of a hinge reinforcement 10 to be secured to a bearing structure 14, but do not explicitly show the attachment bolts provided for attachment purposes, and a hinge joint correspondingly designed with the hinge reinforcement 10. As evident from FIG. 2, the hinge reinforcement 10 exhibits three components, specifically a lower plate 22, an upper plate 20 lying over it, and a bracket 12. The lower plate 22 has a slotted recess 32 for accommodating an adhesive 34, which is later placed in the recess 32 during assembly of the hinge reinforcement 10 at the latest.

The two plates 20, 22 forming the base plate 16 also exhibit mutually aligning through openings 24, 26 for an attachment bolt. The top side of the upper plate 20 also is provided with nuts 18 for the attachment bolt not explicitly shown here. These nuts 18 or comparable attachment means can be designed as weld or clinch nuts, for example, and be permanently secured to the upper plate 20. In the area of the recess 32, the upper plate 20 has no corresponding opening, so that the stacked plates form a receptacle that is only open on one side toward the top for the adhesive 34 preferably coated with a plastic film.

The upper plate 20 also exhibits individual projections or extensions 30, 28, which can be used to slidably secure the base plate 16 to the bearing structure 14, for example an attachment sheet, a door frame or a door shell. The strap-like retainer has a respective through opening 42 at the level of extensions 28, and a through opening 38 at the level of extension 30. Attachment extensions 36, 44 that downwardly border each through opening 38, 42 and face the bearing structure 14 are provided on the bracket 12, and can be used to weld the bracket 12 onto the bearing structure 14, for example.

The outwardly tapering progression of the extension 30 allows the base plate 16 to shift both in the longitudinal and transverse direction relative to the bracket 12 and/or relative to the bearing structure 14. As a result, the base plate 16 can be shifted accordingly relative to the bracket 12 and relative to the bearing structure 14 in the course of an assembly process. In light of its shifting capability, the bearing structure 14 exhibits a sufficiently large through opening (not explicitly shown) that aligns with the through openings 24, 26 of the two plates 20, 22.

In the configuration depicted on FIG. 1, the base plate 16 and its nuts 18 can be adjusted and correspondingly positioned based on the positioning and alignment of the motor vehicle door on the bearing structure 14. The pressure pad 40 provided on the bracket 12 and pointing inwardly toward the upper plate 20 here makes a clamping force directed downwardly toward the bearing structure 14, which is intended to prevent spontaneous slippage by the base plate 16.

As soon as a final assembly configuration has been reached, the attachment bolts can be tightened with the nuts 18 to yield a clamping configuration of the hinge reinforcement 10 and a hinge joint provided on the opposing side of the bearing structure 14. The door is hence rigidly secured to the vehicle body in its final assembly configuration. When the entire vehicle body then goes through a subsequent coating and possible drying process, the film enveloping the adhesive 34 melts, for example. The adhesive 34 is released, and can dissolve into the recess 32, facilitated as well by the prevailing warmth, and then cure as it forms a firm bond between the base plate 16 and bearing structure 14. As a result, after the coating process is complete, the base plate 16 along with the entire hinge reinforcement 10 is precisely positioned and fixedly secured to the bearing structure 14, even after the screw joint is loosened. The vehicle door can then be reassembled without any readjustment being required.

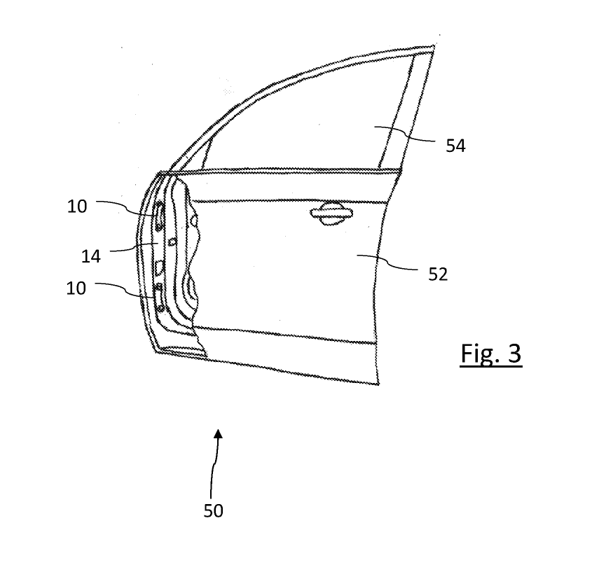

The depiction on FIG. 3 shows a situation where the hinge reinforcement is mounted to a door shell of a vehicle door 50. The vehicle door 50 has an outer door sheet 52 below a window opening 54, which covers the inner components of the door structure in a final assembly configuration. A hinge reinforcement 10 is secured to a front end section of the door structure lying toward the front in the traveling direction, on the face in the area of two respective door hinges.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A hinge reinforcement for a motor vehicle door hinge configured to secure a hinge joint to A bearing structure of a motor vehicle body, comprising:
a bracket;
a base plate slidably attached to a side of the bearing structure facing away from the hinge joint in a pre-assembly position with the bracket; and
a thermally activatable fixing accommodated by the base plate with which the base plate is fixable to the bearing structure in a final assembly position.

2. The hinge reinforcement according to claim 1, wherein the thermally activatable fixing is a thermally activatable adhesive.

3. The hinge reinforcement according to claim 1, wherein the base plate is thermally activatable.

4. The hinge reinforcement according to claim 1, wherein the base plate comprises at least two parts and exhibits an upper plate and a lower plate having through openings for an attachment bolt that passes through the bearing structure and align flush in an assembly position.

5. The hinge reinforcement according to claim 4,
wherein the lower plate abuts the bearing structure in the assembly position, and
wherein the upper plate rests on the lower plate and comprises at least one extension that projects over a side edge of the lower plate that is configured to join the upper plate that is flush with the bracket.

6. The hinge reinforcement according to claim 5, wherein the bracket is a strap that at least regionally overlaps the base plate.

7. The hinge reinforcement according to claim 5, wherein the bracket comprises at least one through opening configured to accommodate an extension of the base plate.

8. The hinge reinforcement according to claim 5, wherein the bracket comprises attachment extensions that in the assembly position extend essentially parallel to a plane of the bearing structure.

9. The hinge reinforcement according to claim 1, wherein the bracket overlaps the base plate transversely relative to a longitudinal direction and the base plate comprises a curved progression viewed in the longitudinal direction in which longitudinal ends of the base plate come to align roughly flush with an outlying edge of an attachment extension of the bracket.

10. The hinge reinforcement according to claim 5, wherein the bracket comprises a clamp configured as a pressure pad facing the base plate.

11. The hinge reinforcement according to claim 4, wherein the lower plate comprises a recess configured to form a receptacle for the fixing.

12. The hinge reinforcement according to claim 1, wherein the bearing structure is part of a vehicle door.

13. The hinge reinforcement according to claim 1, wherein the bearing structure is part of a vehicle body.

14. A method for assembling a vehicle door to a body of a motor vehicle using a hinge reinforcement, comprising:
slidably securing a base plate of the hinge reinforcement with a bracket to a bearing structure in a pre-assembly position and a door hinge;
engaging a the base plate with an attachment that penetrates through the base plate to clamp the bearing structure between the door hinge and the base plate;
subjecting at least the base plate to a thermal treatment in which a fixing arranged with respect to the base plate and abuts the bearing structure that is thermally activated.
